(19) United States
(12) Patent Application Publication
(10) Pub. No.: US 2015/0158656 A1
(43) Pub. Date: Jun. 11, 2015

(54) THERMAL CONTAINER, THERMAL LINER FOR SAME AND DIES FOR MAKING THE THERMAL LINER

(71) Applicant: FRESH BAILIWICK INC., Dartmouth (CA)

(72) Inventor: Alan McKinnon, Dartmouth (CA)

(73) Assignee: FRESH BAILIWICK INC., Dartmouth (CA)

(21) Appl. No.: 14/231,071

(22) Filed: Mar. 31, 2014

Related U.S. Application Data
(60) Provisional application No. 61/913,606, filed on Dec. 9, 2013.

(51) Int. Cl. B65D 81/38; B65D 5/56; B31B 3/14

(52) U.S. Cl. CPC B65D 81/3818; B31B 3/14; B65D 5/566; B31B 2241/00

(57) ABSTRACT

A thermal liner for a container comprises a bottom panel hingedly connected to a pair of opposed medial end panels and a pair of opposed side panels; four outer end panels each being hingedly connected along a first edge to a corresponding side panel and along a second edge to a corresponding medial end panel and being foldable along a diagonal thereof; a pair of opposed side flaps each being hingedly connected along an edge to a corresponding side panel; and end flaps hingedly connected along a first edge to one of a corresponding outer end panel or a corresponding side flap and having a free edge adjacent to the other one of the corresponding end panel or the corresponding side flap. There is also provided a thermal container comprising such a liner and a pair of dies for forming the thermal liner are also described.

### CROSS REFERENCE TO RELATED APPLICATION

This application claims the benefit under 35 U.S.C. §119(e) of Provisional Application Ser. No. 61/913,606 filed Dec. 9, 2013 which is hereby incorporated by reference in its entirety.

### FIELD OF THE INVENTION

This invention relates to thermal containers. More particularly, it relates to a thermal container, a thermal liner for such a container, as well as dies for forming the thermal liner.

### BACKGROUND

It is known in the art to use materials such as waxed corrugate and honeycomb material covered by an aluminum foil layer or a metallized film layer in the manufacture of foldable thermal liners insertable into a box to form a thermal container used for packing perishable goods for temporary storage and/or shipping thereof. In order to maintain the perishable goods in a refrigerated state, a refrigerant such as ice, frozen gel packs or the like is usually placed in the thermal container along with the goods.

For example, it is known to pack fresh fish in a bag, surround the bag with a frozen gel-pack or ice, and place the bag and refrigerant in one of the above described thermal container for transport from a processing facility to a warehouse. Such a solution offers an affordable alternative which advantageously allows the thermal containers to be configured in a folded non-operative configuration when not being used and be configured into an erected configuration when the need for packing the perishable goods arises.

In order to make the liners for the above described thermal containers, it is known to form crease lines into a liner blank to allow easy folding thereof, such as to generate a liner easily insertable into a box. However, the production of such a liner blank onto which the crease lines are formed to allow proper folding, generally requires the removal of sections of material (most commonly corner sections) from a rectangular blank. Such removal of sections of material from a rectangular blank is not cost efficient and environment friendly as it causes loss of material and increases waste. Moreover, in some cases the insulation properties of the resulting thermal container has proved unsatisfactory to maintain the goods in a refrigerated state for sufficient time periods.

In view of the above, there is a need for a thermal container, thermal liner for such a container, as well as dies for making the thermal liner which would be able to overcome or at least minimize some of the above-discussed prior art concerns.

### SUMMARY OF THE INVENTION

According to a first general aspect, there is provided a thermal liner for a container. The thermal liner comprises: a bottom panel hingedly connected to a pair of opposed medial end panels and a pair of opposed side panels; four outer end panels, each one of the outer end panels being hingedly connected along a first edge to a corresponding one of the side panels and along a second edge to a corresponding one of the medial end panels, each one of the outer end panels also being foldable along a diagonal thereof; a pair of opposed side flaps, each one of the side flaps being hingedly connected along an edge to a corresponding one of the side panels; and end flaps hingedly connected along a first edge to one of a corresponding one of the outer end panels and a corresponding one of the side flaps and having a free edge adjacent to the other one of the corresponding one of the outer end panels and the corresponding one of the side flaps.

In an embodiment, the thermal liner further comprises a top sheet spaced from a bottom sheet by a core, the top sheet, the bottom sheet and the core together defining a thickness of the thermal liner.

In an embodiment, the core is composed of a plurality of cellulosic fiber based structures extending between the top sheet and the bottom sheet.

In an embodiment, the plurality of cellulosic fiber based structures are honeycomb-shaped cells formed by cellulosic fiber based walls extending transversely between the top sheet and the bottom sheet.

In an embodiment, the cellulosic fiber based structures are at least partially crushed in each one of the end flaps, each one of the end flaps being thinner than the thickness of the bottom panel of the thermal liner.

In an embodiment, the cellulosic fiber based structures are at least partially crushed in each one of the outer end panels, each one of the outer end panels being thinner than the thickness of the bottom panel of the thermal liner.

In an embodiment, each one of the medial end panels comprises at least one crushed section where the cellulosic fiber based structures are at least partially crushed, each one of the at least one crushed section of each one of the medial end panels being thinner than the thickness of the bottom panel of the thermal liner.

In an embodiment, the at least one crushed section of each one of the medial end panels has an outline substantially matching that of an adjacent one of the outer end panels folded along the diagonal thereof.

In an embodiment, each one of the end flaps is hingedly connected along the first edge to an adjacent one of the outer end panels and is detached along the second edge from an adjacent one of the side flaps.

In an embodiment, each one of the side flaps comprises at least one crushed section where the cellulosic fiber based structures are at least partially crushed, each one of the at least one crushed section extending inwardly from an end and being thinner than the thickness of the thermal liner.

In an embodiment, the at least one crushed section of each one of the side flaps has an outline substantially matching that of an adjacent one of the end flaps.

In an embodiment, an outermost layer of the top sheet comprises a metallized film layer.

In an embodiment, an outermost layer of the bottom sheet comprises a metallized film layer.

According to another general aspect, there is also provided a thermal container. The thermal container comprises: a container having a container bottom wall; a pair of opposed container side walls; and a pair of opposed container end walls. The thermal container also comprises a thermal liner lining the container. The thermal liner comprises: a liner bottom panel hingedly connected to a pair of opposed liner medial end panels and a pair of opposed liner side panels, the liner bottom panel being juxtaposed to the container bottom wall, each one of the liner medial end panels being juxtaposed to a corresponding one of the container end walls and each one of the liner side panels being juxtaposed to a corresponding one of the container side walls; a liner outer end panel hingedly connected between each combination of liner side panels and liner medial end panels, each one of the liner outer end panels being folded along a diagonal thereof and being juxtaposed to an adjacent one of the liner medial end panels; a liner side flap hingedly connected to each one of the liner side panels; and a liner end flap hingedly connected to either each one of the liner outer end panels and being detached from an adjacent one of the liner side flaps or each one of the liner side flaps and being detached from an adjacent one of the liner outer end panels. The liner side flaps and the liner end flaps are configurable in a closed configuration.

In an embodiment, the container further comprises at least two container flaps, each one of the container flaps being hingedly connected to either one of the container side walls or one of the container end walls, the at least two container flaps being configurable in a closed configuration.

In an embodiment, the thermal liner further comprises a top sheet spaced from a bottom sheet by a core, the top sheet, the bottom sheet and the core together defining a thickness of the thermal liner.

In an embodiment, the core of the thermal liner is composed of a plurality of cellulosic fiber based structures extending between the top sheet and the bottom sheet.

In an embodiment, the plurality of cellulosic fiber based structures are honeycomb-shaped cells formed by cellulosic fiber based walls extending transversely between the top sheet and the bottom sheet.

In an embodiment, the cellulosic fiber based structures are at least partially crushed in each one of the liner end flaps, each one of the liner end flaps being thinner than the thickness of the thermal liner.

In an embodiment, the cellulosic fiber based structures are at least partially crushed in each one of the liner outer end panels, each one of the liner outer end panels being thinner than the thickness of the thermal liner.

In an embodiment, each one of the liner medial end panels comprises at least one crushed section where the cellulosic fiber based structures are at least partially crushed, each one of the at least one crushed section of each one of the liner medial end panels being thinner than the thickness of the thermal liner.

In an embodiment, the at least one crushed section of each one of the liner medial end panels has an outline substantially matching that of an adjacent one of the liner outer end panels folded along the diagonal thereof.

In an embodiment, each one of the liner end flaps is hingedly connected to an adjacent one of the outer end panels and is detached from an adjacent one of the side flaps along a free edge.

In an embodiment, each one of the side flaps comprises at least one crushed section extending inwardly from the free edge thereof and where the cellulosic fiber based structures are at least partially crushed, each one of the at least one crushed section being thinner than the thickness of the thermal liner.

In an embodiment, the at least one crushed section of each one of the side flaps has an outline substantially matching that of an adjacent end flap.

In an embodiment, an outermost layer of the top sheet of the thermal liner comprises a metallized film layer.

In an embodiment, an outermost layer of the bottom sheet of the thermal liner comprises a metallized film layer.

According to yet another general aspect, there is also provided a pair of dies for forming a liner for a thermal container. The pair of dies comprises: a first die and a second die, each one of the first die and the second die having a frame with an outer edge. At least one of the first die and the second die comprises a set of bottom panel creasing rules arranged in a rectangular configuration and protruding from the frame, the set of bottom panel creasing rules including a pair of substantially parallel longitudinal rules and a set of substantially parallel lateral rules spaced apart from one another; medial end panel creasing rules protruding from the frame, each one of the medial end panel creasing rules extending laterally between the junction of one of the longitudinal rules and one of the lateral rules of the set of bottom panel creasing rules and the outer edge of the frame; side flap creasing rules protruding from the frame, each one of the side flap creasing rule being substantially parallel to one of the lateral rules of the set of bottom panel creasing rules and spaced apart therefrom; outer end panel creasing rules protruding from the frame, each one of the outer end panel creasing rules extending longitudinally between the junction of one of the longitudinal rules and one of the lateral rules of the set of bottom panel creasing rules and an end of one of the side flap creasing rules; diagonal outer end panel creasing rules protruding from the frame, each one of the diagonal outer end panel creasing rules extending diagonally and outwardly from the junction of one of the longitudinal rules and one of the lateral rules of the set of bottom panel creasing rules towards a point of the outer edge of the frame; cutting members configured to cut a section of the liner, each one of the cutting members extending between the junction of one of the side flap creasing rules and one of the outer end panel creasing rules and the outer edge of the frame; and end flap creasing rules protruding from the frame, each one of the end flap creasing rules extending between one of the cutting member and the outer edge of the frame and being substantially perpendicular to an adjacent one of the cutting members.

In an embodiment, at least one of the first die and the second die comprises corner crushing blocks protruding from the frame, each one of the corner crushing blocks having a surface covering a corner of the frame with a first edge and a second edge defined by the outer edge of the frame, and at least one of a third edge defined by one of the medial end panel creasing rules and a portion of a fourth edge defined by one of the outer end panel creasing rules.

In an embodiment, at least one of the first die and the second die comprises an end flap crushing pad protruding from a section of each one of the corner crushing blocks, each one of the end flap crushing pad being positioned between the outer edge of the frame, a corresponding end flap creasing rule and a corresponding cutting member.

In an embodiment, at least one of the first die and the second die comprises medial end panel crushing blocks, each one of the medial end panel crushing blocks protruding from the frame and having a triangular configuration with a first edge proximate to outer edge of the frame and a second edge proximate to a corresponding one of the medial end panel creasing rules.

In an embodiment, each one of the cutting members extends longitudinally and each one of the end flap creasing rules extends laterally.

In an embodiment, each one of the cutting members extends laterally and each one of the end flap creasing rules extends longitudinally.

In an embodiment, at least one of the first die and the second die comprises side flaps crushing blocks, each one of the side flap crushing blocks having a rectangular configuration with a first edge proximate to the outer edge of the frame, a second edge proximate to the cutting member, a third edge proximate to a corresponding side flap creasing rule and a fourth edge substantially parallel and spaced apart from the second edge.

In an embodiment, each one of the cutting members comprises a blade protruding from the first die and a blade receiving member defined into the frame of the second die.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a partially cut away top perspective view of a thermal liner, according to an embodiment.

FIG. 2 is a bottom perspective view of the thermal liner of FIG. 1.

FIG. 3 is a top perspective view of the thermal liner of FIG. 1 shown in a partially folded liner configuration.

FIG. 4 is an exploded view of a thermal container, according to an embodiment.

FIG. 5 is a perspective view of the thermal container of FIG. 4, shown in a partially closed configuration where the end flaps of the liner are unfolded.

FIG. 6 is a perspective view of the thermal container of FIG. 4, shown in another partially closed configuration where the end flaps of the liner are folded and the thermal liner is configured in a closed configuration.

FIG. 7 is a perspective view of the thermal container of FIG. 4, shown in a closed configuration.

FIG. 8 is a partial cross-sectional view of the thermal container of FIG. 4, taken along lines 8-8 of FIG. 7.

FIG. 9 is a top perspective view of a top die to be used in the making the liner of FIG. 1, according to an embodiment.

FIG. 10 is a top perspective view of a bottom die to be used in the making of the liner of FIG. 1, according to an embodiment.

FIG. 11 is a perspective view of the top die and bottom die of FIGS. 9 and 10, where the top die is positioned to be pressed against the bottom die.

### DETAILED DESCRIPTION

In the following description, the same numerical references refer to similar elements. The embodiments, geometrical configurations, materials mentioned and/or dimensions shown in the figures or described in the present description are preferred embodiments only, given solely for exemplification purposes.

Moreover, although the embodiments of the thermal container, the thermal liner for such a container and the die for making the thermal liner consist of certain geometrical configurations and components, as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

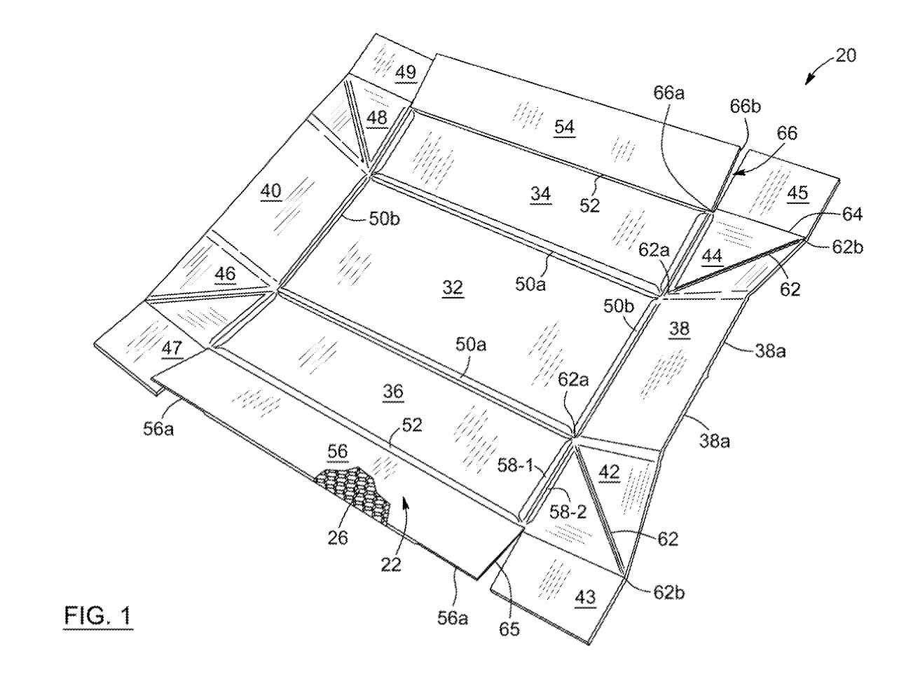

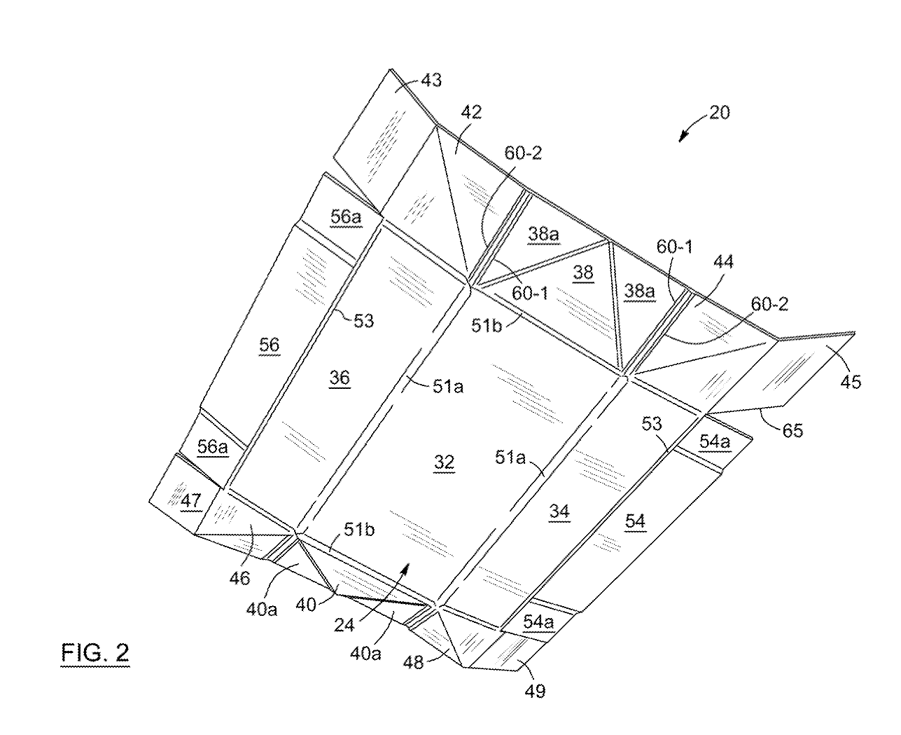

Referring generally to FIGS. 1 and 2, in accordance with an embodiment, there is provided a thermal liner 20 obtained from a liner blank. The liner blank comprises a top sheet 22, a bottom sheet 24, and a core 26. In an embodiment, the top sheet 22 and the bottom sheet 24 are each composed of an outer metallized film layer laminated to a cellulosic fiber based layer, such as a Kraft liner board paper or the like. In an embodiment, the metallized film layer may be formed of a film such as, for example and without being limitative, a polyethylene film, a polypropylene film or the like, onto which aluminum is vaporized. In an alternative embodiment, the top sheet 22 and the bottom sheet 24 could each be composed of a foil layer, or a layer of material offering similar insulating characteristics, laminated to a plastic substrate, such as a polyethylene substrate, a polyester substrate or the like which is further laminated to the cellulosic fiber based layer. One skilled in the art will also understand that, in other alternative embodiments, other combinations offering similar insulating properties may also be used to compose the top sheet 22 and/or the bottom sheet 24.

The core 26 separates the top sheet 22 and the bottom sheet 24, and creates an air filled insulating space therebetween. In an embodiment, the core 26 is composed of a of a plurality of cellulosic fiber based structures extending between the top sheet 22 and the bottom sheet 24, For example and without being limitative, in an embodiment, the plurality of cellulosic fiber based structures are honeycomb-shaped cells formed by cellulosic fiber based walls, such as Kraft paper walls or the like, extending transversely between the top sheet 22 and the bottom sheet 24. One skilled in the art will understand that, in alternative embodiments, other structures providing the air filled insulating space between the top sheet 22 and the bottom sheet 24 could also be provided. Together, the top sheet 22, the bottom sheet 24, and the core 26, in an expanded (or uncrushed) state, define the thickness of the liner blank.

As will be described in more details below, to obtain the thermal liner 20, a combination of crease lines and cut lines formed in the liner blank, such as to define a plurality of panels and flaps for the liner blank to be configurable into the thermal liner 20. Each crease line is formed into the liner blank either from the top sheet 22 or from the bottom sheet 24. In the course of the present document, crease lines formed into the liner blank from the top sheet 22 will be referred to as top crease lines and crease lines formed into the liner blank from the bottom sheet 24 will be referred to as bottom crease lines.

As can be seen in FIGS. 1 and 2, the multiple crease lines and cut lines formed on the liner blank together define a bottom panel 32, a pair of opposed side panels 34, 36, a pair of opposed medial end panels 38, 40, four outer end panels 42, 44, 46, 48, a pair of opposed side flaps 54, 56 and four end flaps 43, 45, 47, 49.

An edge of the bottom panel 32 is hingedly connected to the side panels 34, 36 by top crease lines 50a and corresponding bottom crease lines 51a and an edge of the bottom panel 32 is hingedly connected to the medial end panels 38, 40 by top crease lines 50b and corresponding bottom crease lines 51b. An edge of each one of the side flaps 54, 56 is hingedly connected to the corresponding one of the adjacent side panels 34, 36 by a top crease line 52 and a corresponding bottom crease line 53. It will be understood that the bottom crease lines 51a, 51b and 53 are substantially aligned with the corresponding top crease lines 50a, 50b, 52 to allow the panel to be bended therealong. In an alternative embodiment, bottom crease lines 51a, 51b and 53 may be omitted. In such an embodiment, the predictability in the folds of the thermal liner 20 when erected to fit into an interior space of a container may however be negatively affected.

One outer end panel 42, 44, 46, 48, is hingedly connected between each combination of side panels 34, 36 and medial end panels 38, 40 of the thermal liner 20. In an embodiment, an edge of each outer end panel 42, 44, 46, 48 is hingedly connected to the corresponding adjacent side panel 34, 36 by a pair of substantially parallel top crease lines 58-1, 58-2. Each top crease line 58-1 is substantially aligned with a corresponding one of the top crease lines 50b formed between the bottom panel 32 and the corresponding medial end panels 38, 40. Furthermore, an edge of each outer end panel 42, 44, 46, 48 is hingedly connected to a corresponding medial end panel 38, 40 by a pair of substantially parallel bottom crease lines 60-1, 60-2. Each bottom crease line 60-1 is substantially aligned with a corresponding bottom crease line 51a formed between the bottom panel 32 and the corresponding side panel 34, 36. In an embodiment, the pairs of substantially parallel crease lines 58-1, 58-2 and 60-1, 60-2 are spaced apart by about the thickness of the liner blank.

One skilled in the art will understand that the pairs of substantially parallel crease lines 58-1, 58-2 and 60-1, 60-2 are provided to help the folding of the thermal liner 20 therealong. However, in an alternative embodiment, a single crease line could be provided instead of each pair of substantially parallel crease lines 58-1, 58-2 and 60-1, 60-2.

Each one of the outer end panels 42, 44, 46, 48 also includes a diagonal top crease line 62 (or diagonally-extending crease line). Each diagonal top crease line 62 extends between a first end 62a located at the junction of the corresponding top crease line 58-1 and bottom crease line 60-1 and a second end 62b at the opposed corner of the outer end panel 42, 44, 46, 48, for each one of the outer end panels 42, 44, 46, 48 to be foldable therealong.

In the illustrated embodiment, en edge of each end flap 43, 45, 47, 49 is hingedly connected to an adjacent one of the outer end panels 42, 44, 46, 48 by a top crease line 64. Each crease line 64 is substantially parallel to crease lines 52, 53 formed between the side panel 34, 36 and the corresponding side flap 54, 56, but is offset towards the outer edge of the thermal liner 20 in comparison to the crease lines 52, 53. In an embodiment, the crease line 64 is offset outwardly towards the outer edge of the thermal liner 20 by about the thickness of the liner blank. One skilled in the art would understand that, in an embodiment (not shown), a corresponding bottom crease line substantially aligned with the corresponding top crease line 64 could also be provided.

Each end flap 43, 45, 47, 49 is also disconnected from the adjacent side flap 54, 56 by a cut line 66 therebetween at a free edge 65 thereof. The cut line 66 disconnects the end flaps 43, 45, 47, 49 from the side flaps 54, 56 along the free edge 65 thereof, by providing a slit extending throughout the thermal liner 20 therebetween. Each cut line 66 extends between a first end 66a located at the junction the corresponding top crease lines 58-1 and 52 and a second end 66b located at the outer edge of the thermal liner 20.

One skilled in the art will understand that, in an alternative embodiment (not shown), the crease line 64 and cut line 66 of each end flap 43, 45, 47, 49 could be inverted. Therefore, in such an embodiment, a crease line would be provided between each side flap 54, 56 and corresponding end flap 43, 45, 47, 49 and a cut line would be provided between each outer end panel 42, 44, 46, 48 and corresponding end flap 43, 45, 47, 49.

In an embodiment, each one of the outer end panels 42, 44, 46, 48 and end flaps 43, 45, 47, 49 has a reduced thickness resulting from pressing the top 22 and bottom 24 sheets toward one another, in order to at least partially crush the structure forming of the core 26 in this section of the thermal liner 20.

In an embodiment, crushed sections 38a, 40a of the medial end panels 38, 40 and crushed sections 54a, 56a of the side flaps 54, 56 also present a reduced thickness resulting from the pressing of the top 22 and bottom 24 sheets toward one another, in order to at least partially crush the structure forming the core 26 in these sections of the thermal liner 20.

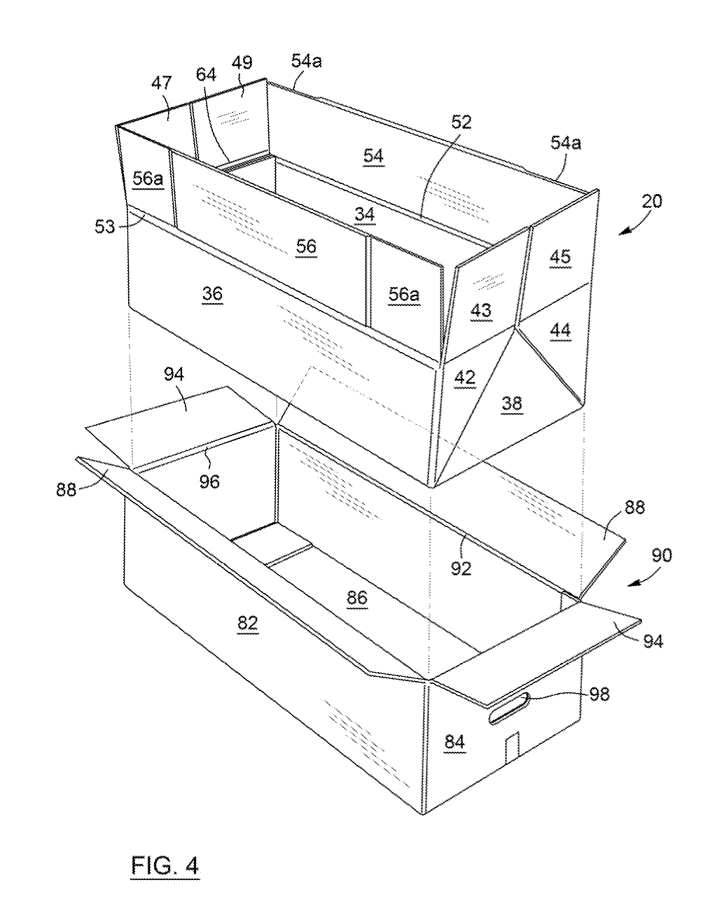

As will be better understood in light of the description below, the reduced thickness of the outer end panels 42, 44, 46, 48, the end flaps 43, 45, 47, 49, and the crushed sections 38a, 40a of the medial end panels 38, 40 and crushed sections 54a, 56a, of the side flaps 54, 56 correspond to sections which are juxtaposed to one another when the thermal liner 20 is folded to be inserted into a corresponding box 90 (See FIG. 4). Therefore, in an embodiment, the crushed sections 38a, 40a have an outline substantially matching that of the folded outer end panels 42, 44, 46, 48 (as will be described in more details below), and the crushed sections 54a, 56a extend inwardly from one of the free edges 65 of the corresponding one of the side flaps 54, 56 and have an outline substantially matching that of an adjacent one of the end flaps 43, 45, 47, 49.

As will be better understood in light of the description below, the reduced thickness of the specific sections help the folded thermal liner erected from the unfolded thermal liner 20 to fit into a corresponding container, such as, without being limitative, a box 90 (See FIG. 4), by reducing the overall thickness of portions where sections of the thermal liner 20 overlap. In the illustrated embodiment, the reduced thickness of crushed sections 38a, 40a, of the medial end panels 38, 40 and crushed sections 54a, 56a of the side flaps 54, 56 creates a depression in the bottom sheet 24 of the thermal liner 20 having an outline substantially matching the juxtaposed sections of the erected thermal liner 20, in order to receive the juxtaposed sections therein, as will be better explained below.

However, one skilled in the art would understand that, in an alternative embodiment (not shown), the crushed sections 54a, 56a of the side flaps 54, 56 could rather create a depression in the top sheet 22 of the thermal liner 20, as will be explained in more details below. Moreover, in another alternative embodiment (not shown), the thermal liner 20 could be provided without crushed portions. In such an embodiment, the thermal liner 20 should nevertheless be configured such that the outer dimensions of the erected liner 20 allow the erected liner 20 to be fitted into the box 90, thereby resulting in the thermal liner 20 offering less interior space.

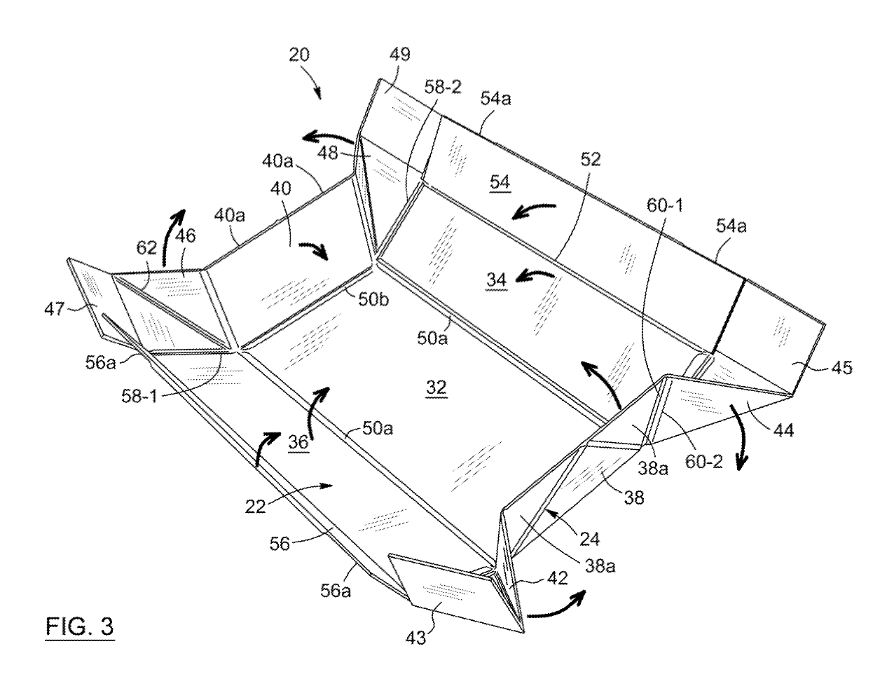

Now referring to FIGS. 3 to 6, a progressive erection of the thermal liner 20 and insertion of the erected thermal liner 20 into the box 90 is shown. FIG. 3 shows the thermal liner 20 in a partially folded configuration and illustrates the direction in which each panel is folded to erect the resulting erected thermal liner 20 shown in FIG. 4.

As can be seen in FIGS. 3 and 4, when the thermal liner 20 shown in FIGS. 1 and 2 is erected, the top sheet 22 of the thermal liner 20 becomes an inner sheet of the liner 20 and the bottom sheet 24 of the thermal liner 20 becomes an outer sheet of the liner 20.

As seen in FIG. 4, when the liner 20 is erected, the outer end panels 42, 44 are each folded in half onto the medial end panel 38. One skilled in the art will understand that, while not visible in FIG. 4, outer end panels 46, 48 are also each folded in half onto end panel 40, such that the liner 20 forms an open container body.

As previously mentioned, the folding into the folded configuration of the liner 20 is facilitated by the above-described combination of top and bottom crease lines. More particularly, the combination of crease lines 50a, 50b and 62 allows the medial end panels 38, 40, and side panels 34, 36 to fold upwardly with respect to the bottom panel 32, each outer end panel 42, 44, 46, and 48 folding in half as a result of crease line 62, upon upward folding of the medial end panels 38, 40, and side panels 34, 36. Pairs of crease lines 58-1, 58-2 and 60-1, 60-2 allow the subsequent folding of each half folded outer end panel 42, 44, 46, 48 against the bottom sheet 24 of the corresponding medial end panel 38, 40. It will be understood that the use of a pair of crease lines 60-1, 60-2 allows the fold at this double crease line to better nestle into the fold at double crease line 58-1, 58-2 when in the folded configuration. The presence of bottom crease lines 51a, 51b facilitate folding of the liner 20 without stress on the material and thereby assist in creating substantially predictable fold lines with about 90° corners.

One skilled in the art will understand that different folding sequences may be performed to obtain the erected configuration shown in FIG. 4 from the thermal liner 20. In an embodiment, all panels adjacent to the bottom panel 32 are folded upward simultaneously, the half folded outer end panels 42, 44, 46, 48 being subsequently folded against the bottom sheet 24 of the corresponding medial end panel 38, 40. However, one skilled in the art will understand that, in an alternative embodiment, the medial end panels 38, 40, outer end panels 42, 44, 46, 48, and end flaps 43, 45, 47, 49, may be firstly folded upwardly simultaneously or sequentially, i.e. the medial end panel 38, outer end panels 42, 44 and end flaps 43, 45 being folded upwardly before the medial end panel 40, outer end panels 46, 48 and end flaps 47, 49 or vice-versa, with the side panels 34, 36 being subsequently folded upwardly simultaneously or sequentially. Inversely, the side panels 34, 36 and outer end panels 42, 44, 46, 48, may be firstly folded upwardly simultaneously or sequentially, with the medial end panels 38, 40 being subsequently folded upwardly simultaneously or sequentially.

The reduced thickness of the outer end panels 42, 44, 46, 48 and crushed sections 38a, 40a, of the medial end panels 38, 40 helps in minimizing the combined thickness of the juxtaposed medial end panel 38, 40, and the outer end panels 42, 44, 46, 48 of the erected liner 20.

Still referring to FIG. 4, when the liner 20 is erected, the crease lines 52, 53 at the top of the side panels 34, 36 are substantially in line with a top edge of the folded medial end panels 38, 40. Each crease line 64 between the outer end panels 42, 44, 46, 48 and the end flaps 43, 45, 47, 49 is slightly above the top edge of the folded medial end panels 38, 40.

Referring to FIGS. 4 to 9, the erected liner 20 may be slid into the box 90 in order to form a thermal container. In an embodiment, the box 90 includes side walls 82, end walls 84, a bottom wall 86 and a side flap 88 hingedly connected along an edge to each side wall 82 at a hinge line 92 and an end flap 94 hingedly connected along en edge to each end wall 84 at a hinge line 96. In an embodiment, the box 90 may be, for example and without being limitative, a corrugated box and each of the end walls may include a cut out 98 to provide a hand grip. One skilled in the art would understand that, in an alternative embodiment (not shown), a container different from the box 90 of the illustrated embodiment could be used.

When the liner 20 is inserted in the box 90, the liner bottom panel 32 is juxtaposed to the box bottom wall 86, each one of the liner medial end panels 38, 40 is juxtaposed to a corresponding one of the box end walls 84 and each one of the liner side panels 34, 36 is juxtaposed to a corresponding one of the container side walls 82. Each one of the liner outer end panels 42, 44, 46, 48 is folded along a diagonal thereof and is juxtaposed to an adjacent one of the liner medial end panels 38, 40, thereby being juxtaposed between the adjacent one of the liner medial end panels 38, 40 and the corresponding one of the box end walls 84.

Moreover, when the liner 20 is inserted in the box 90, the bottom crease lines 53 ease the folding of the side flaps 54, 56 of the liner 20 outwardly to increase the size of the top opening of the liner 20, in order to facilitate the loading of articles therein.

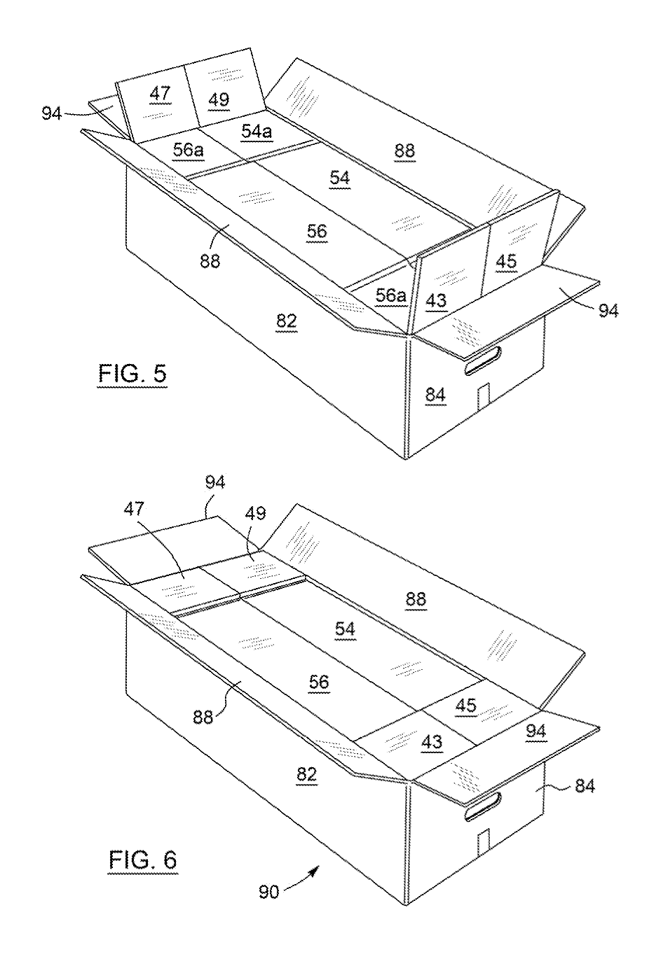

In an embodiment, the liner 20 and the box 90 are sized and shaped such that after the liner 20 has been inserted in the box 90, the crease lines 64 between each outer end panel 42, 44, 46, 48 and each end flap 43, 45, 47, 49 lie slightly above, at, or slightly below the level of box hinge lines 96 and such that side flaps 88 and end flaps 94 of the box 90 can be folded shut when the end flaps 43, 45, 47, 49 of the liner 20 are folded over the folded side flaps 54, 56 of the liner 20. Indeed, once a user has finished loading articles inside the liner 20, the side flaps 54, 56 of the liner 20 may be folded down, as shown in FIG. 5, and the end flaps 43, 45, 47, 49 can subsequently also be folded down, as shown in FIG. 6. One skilled in the art would understand that, in an alternative embodiment (not shown), the end flaps 43, 45, 47, 49 of the liner 20 may firstly be folded down, with the side flaps 54, 56 being folded down subsequently. In such an embodiment, the crushed sections 54a, 56a of the side flaps 54, 56 could create a depression in the top sheet 22 of the thermal liner 20 rather than the bottom sheet 24 as described above, in order to better receive the end flaps 43, 45, 47, 49 abutted thereon.

As previously mentioned, in an alternative embodiment (not shown) where the end flaps 43, 45, 47, 49 would be hingedly connected along an edge to the side flaps 54, 56 and separated from the outer end panels 42, 44, 46, 48, the closure of the liner 20 would be performed by folding down the side flaps 54, 56 and subsequently folding down the end flaps 43, 45, 47, 49 against the outer end panels 42, 44, 46, 48, before inserting the liner 20 into the box 90.

One skilled in the art would understand that, in an alternative embodiment (not shown), the side flaps 54, 56 of the liner 20 may be sized to overlap when folded down. In such an embodiment, the portions of the side flaps 54, 56 which overlap may be crushed to minimize the combined thickness of the side flaps 54, 56, in the overlapping section, to help the fitting of the liner 20 in the closed box 90.

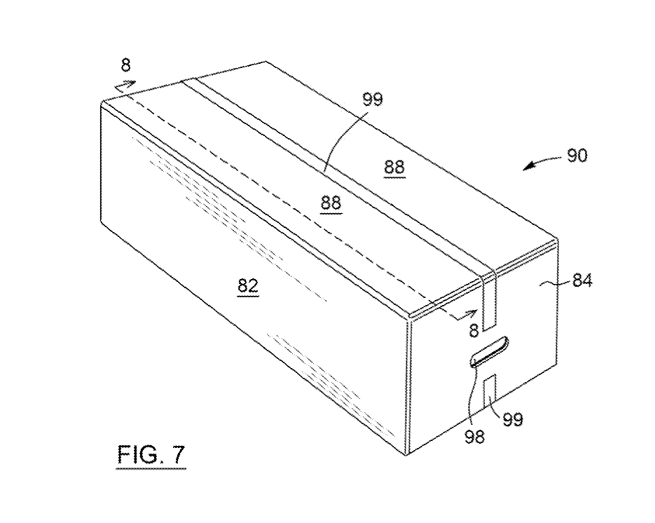

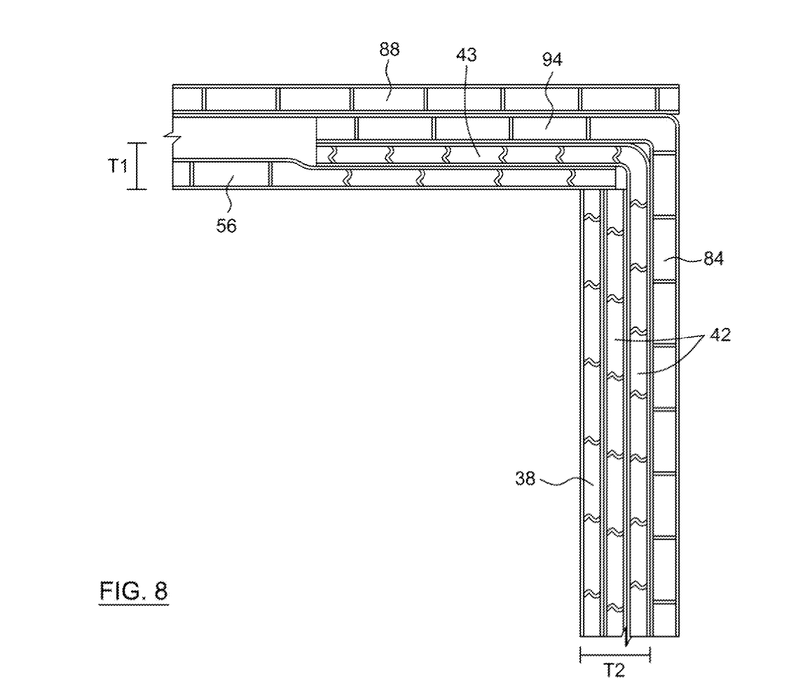

Subsequently, the end flaps 94 and the side flaps 88 of the box 90 may also be folded down to reach the folded configuration of FIG. 7. Once again, and as can be seen in FIG. 8, the reduced thickness of the end flaps 43, 45, 47, 49 and the crushed sections 54a, 56a, of the side flaps 54, 56 help in minimizing the combined thickness T1 of the side flaps 54, 56, and the end flaps 43, 45, 47, 49 of the erected liner 20 to help the fitting of the liner 20 in the closed box 90. Similarly, the reduced thickness of the crushed section 38a, 40a of the medial end panels 38, 40 and the outer end panels 42, 44, 46, 48 also helps in minimizing the combined thickness T2 thereof to help the fitting of the liner 20 in the closed box 90. As seen in FIG. 7, in an embodiment, the box can be taped closed using tape 99 to maintain the box 90 in the shown closed configuration.

Given that the metallized film layer of the top sheet 22 faces the interior of the liner 20 when the box 90 and corresponding liner 20 are closed, the metallized film layer therefore reflects cold back into the liner 20. Similarly, the metallized film layer of the bottom sheet 24 faces the outside of the liner 20 when the box 90 and corresponding liner 20 are closed and therefore reflects heat away from the liner 20. As previously mentioned, the honeycomb core 26 of the liner 20 also limits heat conduction through the liner 20, thereby increasing the insulation properties thereof.

One skilled in the art will understand that, in an alternative embodiment, a liner blank of a different construction could be provided with the above described crease and cut lines patterns. For example and without being limitative, in an embodiment, only the top sheet 22 may be provided with a metallized film layer or a layer of material offering similar insulating characteristics. Moreover, in another non-limitative alternative embodiment, the liner core 26 may be formed of other material, such as corrugate or the like.

It will be understood that the double protection layer provided at the top of the liner 20, by the end flaps 43, 45, 47, 49 laying onto the side flaps 54, 56 in the closed configuration, increases the insulation of the closed liner 20, as it provides an additional insulation layer in the corners of the top surface of the closed liner 20. It will be understood that similar benefits would be obtained with the side flaps 54, 56 laying onto the end flaps 43, 45, 47, 49 in the closed configuration. Moreover, the connection between the end flaps 43, 45, 47, 49 and the outer end panels 42, 44, 46, 48 increases the insulation of the liner 20 by preventing air infiltration therebetween. Furthermore, folding the end flaps 43, 45, 47, 49 over the side flaps 54, 56 covers the elongated groove defined between the edges of the side flaps 54, 56 and the edge of the medial end panels 38, 40 and the folded outer end panels 42, 44, 46, 48 and reduces heat exchange therethrough. Advantageously the above described configuration also allows the liner blank to be formed from a rectangular thermal liner, without the need for removal of the sections corresponding to the end flaps 43, 45, 47, and 49.

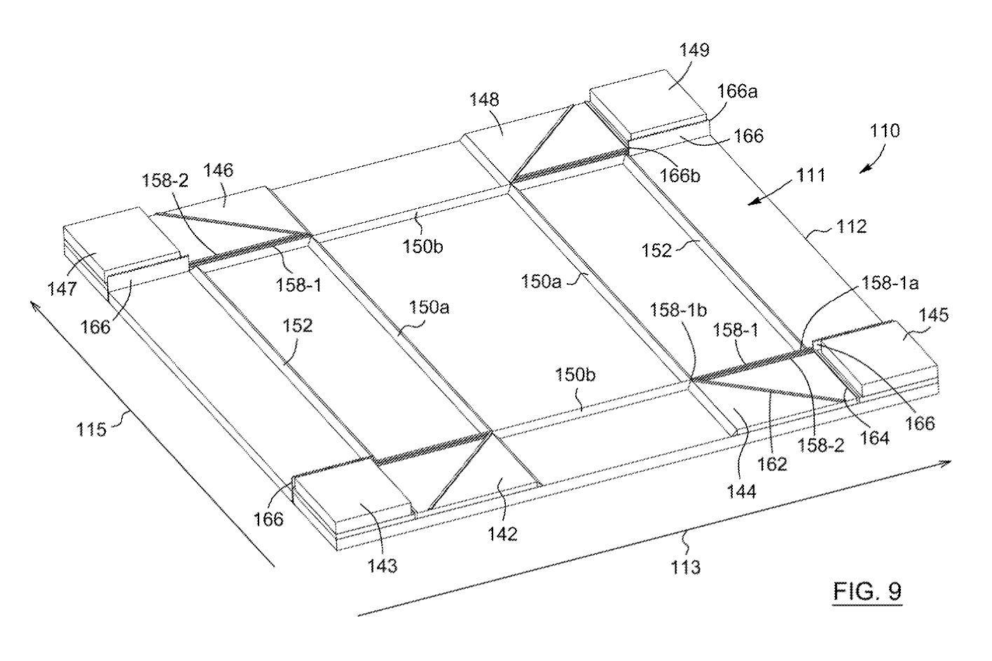

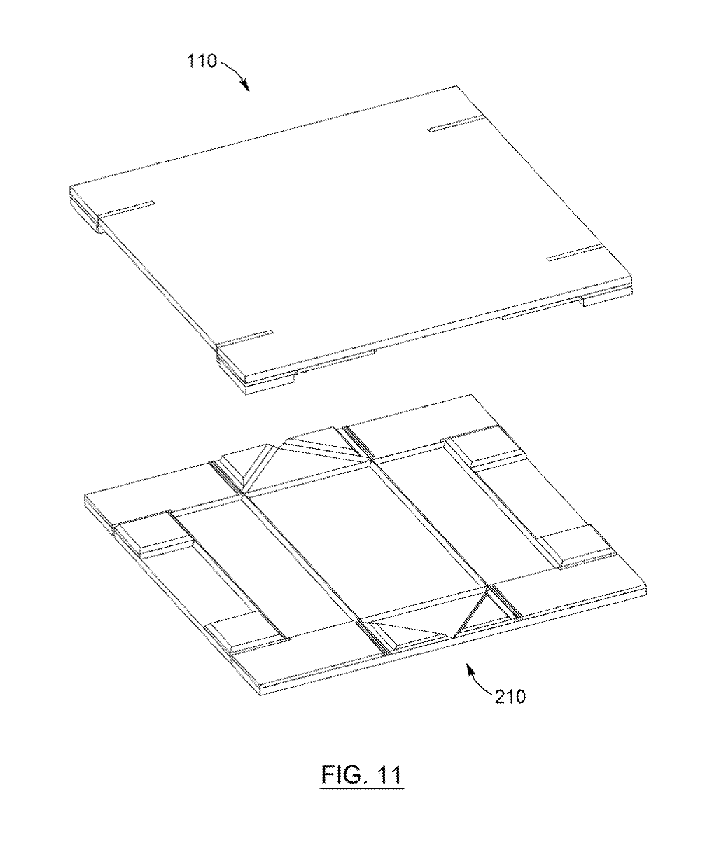

Now referring to FIGS. 9 to 11, an embodiment of a top die 110 and a bottom die 210 used in combination to form the above described thermal liner 20 by pressing the dies onto a liner blank provided therebetween, will be described below.

FIG. 9 shows a top die 110 having a frame 111 with an outer edge 112 of rectangular configuration. The frame 111 extends longitudinally along a longitudinal axis 113 and laterally along a lateral axis 115 and has a combination of crushing blocks, crushing pads, creasing rules, and projecting blades arranged thereon such as to form the above described creasing lines, cutting lines and crushed sections, when pressed against the top sheet 22 of the liner blank. In an embodiment, the frame 111 of the top die 110 is made of a substantially hard material such as wood, plastic, metal, or the like.

In the illustrated embodiment of FIG. 9, the top die 110 includes corner crushing blocks 142, 144, 146, 148 protruding from the frame 111 and defining the corners thereof and positioned to correspond to the outer end panels 42, 44, 46, 48 and the end flaps 43, 45, 47, 49 of the thermal liner 20 (See FIG. 1). One skilled in the art will understand that, in an embodiment, the top die 110 could be free of corner crushing blocks 142, 144, 146, 148.

In the illustrated embodiment of FIG. 9, the top die 110 also includes an end flap crushing pad 143, 145, 147, 149 projecting from a corner section of each one of the corner crushing blocks 142, 144, 146, 148 and corresponding substantially to the end flaps 43, 45, 47, 49 of the thermal liner 20 (see FIG. 1). Each one of the end flap crushing pads 143, 145, 147, 149 is made of a compressible material such as, for example and without being limitative, foam or the like, and protrudes from a corresponding corner crushing block 142, 144, 146, 148 such that an upper surface thereof extends further away from the frame 111 than that of the corresponding corner crushing block 142, 144, 146, 148.

In an embodiment, the top die 110 also includes blades 166 protruding from the frame 111, substantially parallel and proximate to an inner longitudinal edge of a corresponding end flap crushing pad 143, 145, 147, 149. Each blade 166 extends between an outer end 166a at the outer edge 112 of the frame 111 and an inner end 166b located slightly further inwardly from the outer edge 112 of the frame 111 than the inner lateral edge of the corresponding end flap crushing pad 143, 145, 147, 149. The blade is configured to operate in combination with a blade receiving slot in the bottom 210, as will be described in more details below, to cut a section of the liner.

In an embodiment, each blade 166 protrudes from the frame 111 of a distance slightly greater than the thickness of the corresponding end flap crushing pad 143, 145, 147, 149. In other words, the upper edge of each blade is slightly above the upper surface of the corresponding end flap crushing pad 143, 145, 147, 149.

In an embodiment, a pair of outer end panel creasing rules 158-1 and 158-2 protrudes along a portion of an inner longitudinal edge of each corner crushing block 142, 144, 146, 148. One skilled in the art will understand that in an embodiment, the outer end panel creasing rules 158-1, 158-2 could protrude directly from the frame 111 rather than from the corner crushing block 142, 144, 146, 148 protruding from the frame 111. Creasing rules 158-1 extend between a first end 158-1a proximate to the inner end 166b of the corresponding blade 166 and a second end 158-1b proximate to a junction of the inner longitudinal edge and the inner lateral edge of the corresponding corner crushing block 142, 144, 146, 148. Creasing rule 158-2 is located inwardly into the corner crushing block 142, 144, 146, 148 with respect to the corresponding creasing rule 158-1 and is parallel and proximate to the corresponding creasing rule 158-1. Each creasing rule 158-2 extends from the first end 158-1a of the corresponding creasing rule 158-1 and to a point proximate to the second end 158-1b of the corresponding creasing rule 158-1. It will be understood that, in an embodiment, the creasing rule 158-2 extends as close to the second end 158-1b of creasing rule 158-1 as possible, without interfering with a diagonal creasing rule 162 which will be described below.

In an alternative embodiment (not shown), a single outer end panel creasing rule may be provided instead of the pair of outer end panel creasing rules 158-1 and 158-2.

As can be seen in FIG. 9, in the illustrated embodiment an end flap creasing rule 164 also protrudes from each corner crushing block 142, 144, 146, 148 substantially parallel and proximate to an inner lateral edge of the corresponding end flap crushing pad 143, 145, 147, 149 and substantially perpendicular to an adjacent one of the blades 166. Moreover, a diagonal outer end panel creasing rule 162 protrudes from each corner crushing block 142, 144, 146, 148, along a diagonal of a section of each corner crushing block 142, 144, 146, 148 and extends from the second ends 158-1b of creasing rule 158-1 to a point near the junction of creasing rule 164 and the outer edge 112 of the frame 111. Once again, one skilled in the art will understand that in an embodiment, the end flap creasing rules 164 and diagonal outer end panel creasing rules 164 could protrude directly from the frame 111 rather than from the corner crushing block 142, 144, 146, 148 protruding from the frame 111.

In an alternative embodiment (not shown), the blade 166 and corresponding creasing rule 164 could be inverted such that each blade 166 protrudes from the frame 111, substantially parallel and proximate to an inner lateral edge of a corresponding end flap crushing pad 143, 145, 147, 149 and each creasing rule 164 protrudes substantially parallel and proximate to an inner longitudinal edge of the corresponding end flap crushing pad 143, 145, 147, 149.

A pair of substantially parallel lateral creasing rules 150a extending between the second ends 158-1b of creasing rules 158-1 of corner crushing blocks 144 and 148 and between the second ends 158-1b of creasing rules 158-1 of corner crushing blocks 142 and 146 are also provided. A pair of substantially parallel longitudinal creasing rules 150b are further provided longitudinally between second ends 158-1b of creasing rules 158-1 of corner crushing blocks 142 and 144 and between the second ends 158-1b of creasing rules 158-1 of corner crushing blocks 146 and 148. The pairs of substantially parallel lateral creasing rules 150a and substantially parallel longitudinal creasing rules 150b together define a set of bottom panel creasing rules arranged in a rectangular configuration and protruding from the frame 111. Longitudinal creasing rules 150b are substantially in line with the above mentioned creasing rules 158-1 extending along the inner longitudinal edge of each corner crushing block 142, 144, 146, 148.

Each section of the top die 110 between the corner crushing blocks 144 and 148 and between the corner crushing blocks 142 and 146 is divided by a side flap creasing rule 152 protruding laterally from the frame 111 substantially parallel and spaced apart from a corresponding one of lateral creasing rules 150a of the set of bottom panel creasing rules. Creasing rule 152 is slightly offset inwardly from the corresponding creasing rule 164 as it is slightly further from the outer edge 112 of the frame 111 than the corresponding creasing rule 164. In an embodiment the creasing rule 152 is located further from the outer edge 112 of the top die 110 than the corresponding creasing rule 164 of a distance corresponding to the thickness of the side flaps 54, 56 of the thermal liner 20 (see FIG. 1).

As can be seen in FIG. 9, in the illustrated embodiment, each one of the outer end panel creasing rules 158-1, 158-2 therefore extends longitudinally between the junction of one of the longitudinal rules 150b and one of the lateral rules 150a of the set of bottom panel creasing rules and an end of one of the side flap creasing rules 152. Moreover, each one of the diagonal outer end panel creasing rules 164 extends diagonally and outwardly from the junction of one of the lateral rules 150a and one of the longitudinal rules 150b of the set of bottom panel creasing rules towards a point of the outer edge 112 of the frame 111. Each one of the blades 166 of the cutting members extend between a junction of one of the side flap creasing rules 152 and one of the outer end panel creasing rules 158-1, 158-2 and the outer edge 112 of the frame 111. Each one of the end flap creasing rules 164 extends between one of the blades 166 of the cutting member and the outer edge 112 of the frame 111 and is substantially perpendicular to the adjacent one of the blades 166 of the cutting member.

In the illustrated embodiment, each corner crushing block 142, 144, 146, 148 has a surface covering a corner of the frame 111 with two edges defined by the outer edge 112 of the frame 111, and a portion of a another edge defined by one of the outer end panel creasing rules 158-1, 158-2. Each one of the end flap crushing pad 143, 145, 147, 149 is positioned between the outer edge 112 of the frame 111, a corresponding one of the end flap creasing rules 164 and a corresponding one of the blade 166 of the cutting members.

In an embodiment, each corner crushing block 142, 144, 146, 148 and each one of the above mentioned creasing rule is also made of a hard material such as wood, plastic, metal, or the like.

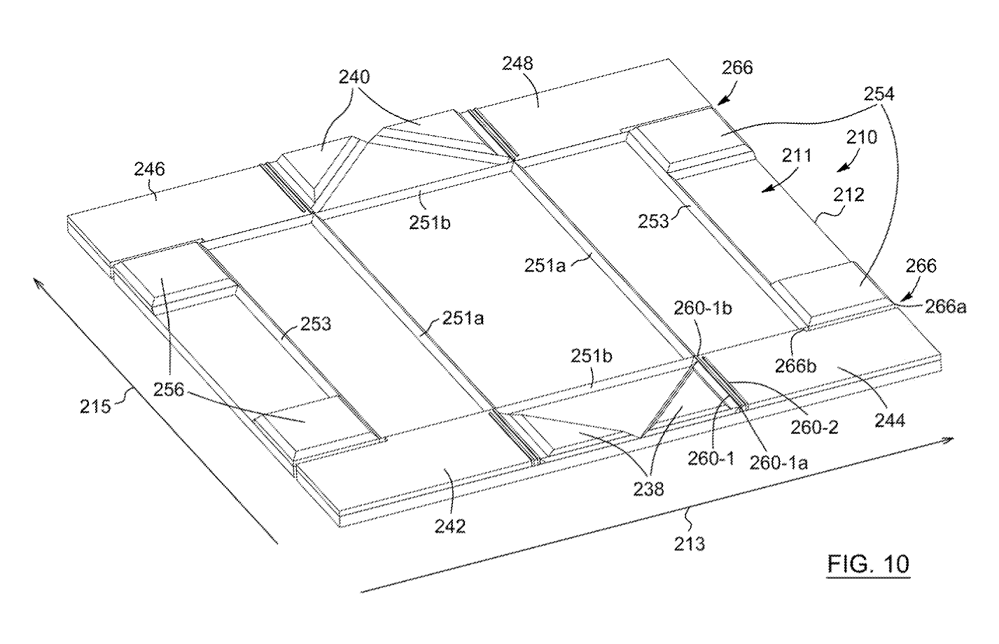

FIG. 10 shows a bottom die 210 also having a frame 211 with an outer edge 212 of rectangular configuration. The frame 211 also extends longitudinally along a longitudinal axis 213 and laterally along a lateral axis 215 and has a combination of crushing blocks, creasing rules, and slots arranged thereon such as to form the above described creasing lines, cutting lines and crushed sections when a liner blank is compressed between the top die 110 and bottom die 210 such that the bottom die 210 is pressed against the bottom sheet 24 of the liner blank. Once again, in an embodiment, the frame 211 of the bottom die 210 is made of a hard material such as wood, plastic, metal, or the like.

The bottom die 210 also has corner crushing blocks 242, 244, 246, 248 protruding from the frame 211 and defining the corners thereof and positioned to correspond to the outer end panels 42, 44, 46, 48 and the end flaps 43, 45, 47, 49 of the thermal liner 20 (see FIG. 1). One skilled in the art will again understand that, in an embodiment, the bottom die 210 could be free of corner crushing blocks 242, 244, 246, 248.

In the illustrated embodiment, a pair of medial end panels creasing rules 260-1, 260-2 protrudes from each one of the corner crushing blocks 242, 244, 246, 248, along the inner lateral edge thereof. One skilled in the art will understand that in an embodiment, medial end panels creasing rules 260-1, 260-2 could protrude directly from the frame 211 rather than from the corner crushing blocks 242, 244, 246, 248 protruding from the frame 211. The Medial end panels creasing rules 260-1 extend between an outer end 260-1a proximate to the outer edge 212 of the frame 211 and an inner end 260-1b at the junction of the inner longitudinal edge and the inner lateral edge of the corresponding corner crushing block 142, 144, 146, 148. Each creasing rule 260-2 is located inwardly into the corner crushing block 142, 144, 146, 148, with respect to the corresponding creasing rule 260-1, and is parallel and proximate to the corresponding creasing rule 260-1. Each creasing rule 260-2 extends from the outer end 260-1a of the corresponding creasing rule 260-1 and to a point proximate to the inner end 260-1b of the corresponding creasing rule 260-1. It will be understood that, in an embodiment, the creasing rule 260-2 extends as close to the inner end 260-1b of creasing rule 260-1 as possible, without interfering with the diagonal creasing rule 162 formed in the top die 110 and described above (See FIG. 9).

In an alternative embodiment (not shown), a single medial end panel creasing rule may be provided instead of each pair of medial end panel creasing rules 260-1 and 260-2.

A pair of substantially parallel lateral creasing rules 251a extending between the inner ends 260-1b of creasing rules 260-1 of corner crushing blocks 244 and 248 and between the inner ends 260-1b of creasing rules 260-1 of corner crushing blocks 242 and 246 are also provided. Lateral creasing rules 251a are substantially in line with the above mentioned creasing rules 260-1 of the medial end panels creasing rules 260-1, 260-2 extending along the inner lateral edge of each crushing block 242, 244, 246, and 248. A pair of substantially parallel longitudinal creasing rules 251b are further provided longitudinally between the inner ends 260-1b of creasing rules 260-1 of corner crushing blocks 242 and 244 and between the inner ends 260-1b of creasing rules 260-1 of corner crushing blocks 246 and 248. The pairs of substantially parallel lateral creasing rules 251a and substantially parallel longitudinal creasing rules 251b together also define a set of bottom panel creasing rules arranged in a rectangular configuration and protruding from the frame 211. Each pair of medial end panels creasing rules 260-1, 260-2 extends laterally between the junction of one of the longitudinal rules 251b and one of the lateral rules 251a of the set of bottom panel creasing rules and the outer edge of the frame 211.

Each one of the free section between corner crushing blocks 244, 248, and between corner crushing blocks 242, 246 is divided by a lateral side flap creasing rule 253 substantially parallel and spaced apart from a corresponding one of lateral creasing rules 251a of the set of bottom panel creasing rules.

In an embodiment, a blade receiving slot 266 for receiving the blade 166 of a top die 110, as described above, is also provided along a portion of the inner longitudinal edge of each corner crushing block 242, 244, 246, 248. The blade receiving slot 266 is a void section defined along the portion of the inner longitudinal edge of each crushing block 242, 244, 246, 248 which spans between an outer end 266a located at the outer edge 212 of the frame 211 and an inner end 266b proximate to an end of the side flap creasing rule 253. The blade receiving slots 266 and the corresponding blade 166 of the top die 110 form cutting members configured to cut a section of the liner. One skilled in the art will understand that, in alternative embodiments, different types of cutting member could be provided.

Each corner crushing block 242, 244, 246, 248 has a surface covering a corner of the frame 211 with two edges defined by the outer edge 212 of the frame 211, and a another edge defined by one of the medial end panels creasing rules 260-1, 260-2.

In an embodiment, the bottom die 210 further comprises medial end crushing blocks 238, 240 and side panels crushing blocks 254, 256 projecting from the frame 211 of the bottom die 210.

The medial end crushing blocks 238, 240 correspond to the crushed section 38a, 40a, of the medial end panels 38, 40 of the thermal liner 20. Therefore, each one of the medial end crushing blocks 238, 240 has a triangular configuration and is positioned proximate to a corresponding corner crushing block 242, 244, 246, 248 such as to have an edge proximate to the outer edge 212 of the frame 211 and an edge proximate to a corresponding one of the medial end panel creasing rules 260-1, 260-2, i.e. proximate to an inner lateral edge of the corresponding corner crushing block 242, 244, 246, 248.

The side flap crushing blocks 254, 256 correspond to the crushed section 54a, 56a of the side flaps 54, 56 of the thermal liner 20. Therefore, each one of the side flaps crushing blocks 254, 256, has a rectangular configuration with an outline substantially matching the outline of the side flaps 54, 56. The side flap crushing blocks 254, 256 are positioned proximate to a corresponding corner crushing block 242, 244, 246, 248 such as to have first edge proximate to the outer edge 212 of the frame 211, a second edge proximate to the blade receiving slot 266, i.e. proximate to the inner longitudinal edge of the corresponding corner crushing block 242, 244, 246, 248 and third edge proximate to a corresponding one of the side flap creasing rules 253 and a fourth edge substantially parallel and spaced apart from the second edge.

In the illustrated embodiment, the thickness of the medial end crushing blocks 238, 240 and of the side flap crushing blocks 254, 256 is greater than that of the corner crushing blocks 242, 244, 246, 248, i.e. the medial end crushing blocks 238, 240 and the side flap crushing blocks 254, 256 extend further away from the frame 211 than the corner crushing blocks 242, 244, 246, 248. In an embodiment, the thickness of the medial end crushing blocks 238, 240 and of the side flap crushing blocks 254, 256 is greater than that of the corner crushing blocks 242, 244, 246, 248 of approximately the thickness of the corner crushing blocks 142, 144, 146, 148 of the top die 110.

Now referring to FIGS. 9 to 11, to form a thermal liner 20 using the above described top die 110 and bottom die 210, a uniform liner blank (not shown) with an outline matching that of the thermal liner of FIG. 1 is compressed between the bottom die 210 and top die 110. The bottom die 210 compresses the bottom sheet of the uniform liner while the top die 110 compresses the top sheet thereof. The bottom die 210 and top die 110 are oriented such that corner crushing blocks 142, 144, 146, and 148 of the top die 110 are in register with corner crushing blocks 242, 244, 246, and 248 of the bottom die 210. Therefore, each one of creasing rules 251a, 251b and 253 of the bottom die 210 are also in register with creasing rules 150a, 150b and 152 of the top die 110 such that, as the bottom die 210 and the top die 110 are brought together, top crease lines 50a, 50b and 52 and bottom crease lines 51a, 51b and 53 are formed in the liner blank. Each one of corner crushing blocks 142, 242, 144, 244, 146, 246, 148, 248 and the corresponding end flap crushing pad have a height sufficient to crush the outer end panels 42, 44, 46, 48 and end flaps 43, 45, 47, 49 therebetween, the end flap crushing pad 143, 145, 147, 149 also being compressed between the corresponding one of the corner crushing blocks 142, 242, 144, 244, 146, 246, 148, 248 to allow proper severing by the blade 166. The medial end crushing blocks 238, 240 and side panels crushing blocks 254, 256 also have a height sufficient to respectively crush the crushed sections 38a, 40a of the medial end panels 38, 40 and the crushed sections 54a, 56a of the side flaps 54, 56. The creasing rules 158-1, 158-2, 162, 164, 260-1 and 260-2 form crease lines 58-1, 58-2, 62, 64, 60-1 and 60-2 in the outer end panels 42, 44, 46, 48 and the blade 166 and blade receiving slot 266 operate to sever a section of the liner blank to allow the end flaps 43, 45, 47, 49 to be separated from the corresponding side flap 54, 56.

One skilled in the art will understand that, in an alternative embodiment, the blade 166, the end flap crushing pad 143, 145, 147, 149 and the blade receiving slot 266 can be inverted between the top die 110 and the bottom die 210. Similarly, the medial end crushing blocks 238, 240 and side panels crushing blocks 254, 256 could be provided on the top die 110 rather than on the bottom die 210. It will also be understood that, in an alternative embodiment, the creasing rules 251a, 251b and 253 may be omitted such that bottom crease lines 51a, 51b and 53 are not formed onto the liner blank.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A thermal liner for a container, the thermal liner comprising:
a bottom panel hingedly connected to a pair of opposed medial end panels and a pair of opposed side panels;
four outer end panels, each one of the outer end panels being hingedly connected along a first edge to a corresponding one of the side panels and along a second edge to a corresponding one of the medial end panels, each one of the outer end panels comprising a diagonally-extending crease line and being foldable therealong;
a pair of opposed side flaps, each one of the side flaps being hingedly connected along an edge to a corresponding one of the side panels; and
end flaps hingedly connected along a first edge to one of a corresponding one of the outer end panels and a corresponding one of the side flaps and having a free edge adjacent to the other one of the corresponding one of the outer end panels and the corresponding one of the side flaps.

2. The thermal liner of claim 1, further comprising a top sheet spaced from a bottom sheet by a core composed of a plurality of cellulosic fiber based structures extending between the top sheet and the bottom sheet, the plurality of cellulosic fiber based structures being honeycomb-shaped cells formed by cellulosic fiber based walls extending transversely between the top sheet and the bottom sheet the top sheet, the bottom sheet and the core together defining a thickness of the thermal liner.

3. The thermal liner of claim 2, wherein the cellulosic fiber based structures are at least partially crushed in each one of the end flaps, each one of the end flaps being thinner than the thickness of the thermal liner.

4. The thermal liner of claim 2, wherein the cellulosic fiber based structures are at least partially crushed in each one of the outer end panels, each one of the outer end panels being thinner than the thickness of the thermal liner.

5. The thermal liner of claim 2, wherein each one of the medial end panels comprises at least one crushed section where the cellulosic fiber based structures are at least partially crushed, each one of the at least one crushed section of each one of the medial end panels being thinner than the thickness of the thermal liner.

6. The thermal liner of claim 5, wherein the at least one crushed section of each one of the medial end panels has an outline substantially matching an outline of an adjacent one of the outer end panels folded along the diagonally-extending crease line.

7. The thermal liner of claim 2, wherein each one of the end flaps is hingedly connected along the first edge to an adjacent one of the outer end panels and is detached along the second edge from an adjacent one of the side flaps.

8. The thermal liner of claim 7, wherein each one of the side flaps comprises at least one crushed section where the cellulosic fiber based structures are at least partially crushed, each one of the at least one crushed section extending inwardly from an end and being thinner than the thickness of the thermal liner.

9. The thermal liner of claim 8, wherein the at least one crushed section of each one of the side flaps has an outline substantially matching an outline of an adjacent one of the end flaps.

10. A thermal container comprising:
a container comprising:
a container bottom wall;
a pair of opposed container side walls; and
a pair of opposed container end walls;
a thermal liner lining the container and comprising:
a liner bottom panel hingedly connected to a pair of opposed liner medial end panels and a pair of opposed liner side panels, the liner bottom panel being juxtaposed to the container bottom wall, each one of the liner medial end panels being juxtaposed to a corresponding one of the container end walls and each one of the liner side panels being juxtaposed to a corresponding one of the container side walls;
a liner outer end panel hingedly connected between each combination of liner side panels and liner medial end panels, each one of the liner outer end panels being folded along a diagonal thereof and being juxtaposed to an adjacent one of the liner medial end panels;
a liner side flap hingedly connected to each one of the liner side panels; and
a liner end flap hingedly connected to either each one of the liner outer end panels and being detached from an adjacent one of the liner side flaps or each one of the liner side flaps and being detached from an adjacent one of the liner outer end panels;
wherein the liner side flaps and the liner end flaps being configurable in a folded configuration closing an interior space of the thermal container.

11. The thermal container of claim 10, wherein the container further comprises at least two container flaps, each one of the container flaps being hingedly connected to either one of the container side walls or one of the container end walls, the at least two container flaps being configurable in a closed configuration juxtaposed to the liner side flaps configured in the folded configuration.

12. The thermal container of claim 10, wherein the thermal liner further comprises a top sheet spaced from a bottom sheet by a core composed of a plurality of cellulosic fiber based structures extending between the top sheet and the bottom sheet, the plurality of cellulosic fiber based structures being honeycomb-shaped cells formed by cellulosic fiber based walls extending transversely between the top sheet and the bottom sheet the top sheet, the bottom sheet and the core together defining a thickness of the thermal liner.

13. The thermal container of claim 12, wherein the cellulosic fiber based structures are at least partially crushed in each one of the liner end flaps, each one of the liner end flaps being thinner than the thickness of the thermal liner.

14. The thermal container of claim 12, wherein the cellulosic fiber based structures are at least partially crushed in each one of the liner outer end panels, each one of the liner outer end panels being thinner than the thickness of the thermal liner.

15. The thermal container of claim 12, wherein each one of the liner medial end panels comprises at least one crushed section where the cellulosic fiber based structures are at least partially crushed, each one of the at least one crushed section of each one of the liner medial end panels being thinner than the thickness of the thermal liner.

16. The thermal container of claim 15, wherein the at least one crushed section of each one of the liner medial end panels has an outline substantially matching an outline of an adjacent one of the liner outer end panels folded along the diagonal thereof.

17. The thermal container of claim 12, wherein each one of the liner end flaps is hingedly connected to an adjacent one of the outer end panels and is detached from an adjacent one of the side flaps along a free edge.

18. The thermal container of claim 17, wherein each one of the side flaps comprises at least one crushed section extending inwardly from the free edge and where the cellulosic fiber based structures are at least partially crushed, each one of the at least one crushed section being thinner than the thickness of the thermal liner.

19. The thermal container of claim 18, wherein the at least one crushed section of each one of the side flaps has an outline substantially matching an outline of an adjacent end flap.

20. A pair of dies for forming a liner for a thermal container, the pair of dies comprising:
a first die and a second die, each one of the first die and the second die having a frame with an outer edge and at least one of the first die and the second die comprising:
a set of bottom panel creasing rules arranged in a rectangular configuration and protruding from the frame, the set of bottom panel creasing rules including a pair of substantially parallel longitudinal rules and a set of substantially parallel lateral rules spaced apart from one another;
medial end panel creasing rules protruding from the frame, each one of the medial end panel creasing rules extending laterally between a junction of one of the longitudinal rules and one of the lateral rules of the set of bottom panel creasing rules and the outer edge of the frame;
side flap creasing rules protruding from the frame, each one of the side flap creasing rules being substantially parallel to one of the lateral rules of the set of bottom panel creasing rules and spaced apart outwardly therefrom;
outer end panel creasing rules protruding from the frame, each one of the outer end panel creasing rules extending longitudinally between a junction of one of the longitudinal rules and one of the lateral rules of the set of bottom panel creasing rules and an end of one of the side flap creasing rules;
diagonal outer end panel creasing rules protruding from the frame, each one of the diagonal outer end panel creasing rules extending diagonally and outwardly from a junction of one of the longitudinal rules and one of the lateral rules of the set of bottom panel creasing rules towards a point of the outer edge of the frame;
cutting members configured to cut a section of the liner, each one of the cutting members extending between a junction of one of the side flap creasing rules and one of the outer end panel creasing rules and the outer edge of the frame; and
end flap creasing rules protruding from the frame, each one of the end flap creasing rules extending between an inner end of one of the cutting members and the outer edge of the frame and being substantially perpendicular to an adjacent one of the cutting members.

21. The pair of dies of claim 20, wherein at least one of the first die and the second die comprises corner crushing blocks protruding from the frame, each one of the corner crushing blocks having a surface covering a corner of the frame with a first edge and a second edge defined by the outer edge of the frame, and at least one of a third edge defined by one of the medial end panel creasing rules and a portion of a fourth edge defined by one of the outer end panel creasing rules.

22. The pair of dies of claim 21, wherein at least one of the first die and the second die comprises an end flap crushing pad protruding from a section of each one of the corner crushing blocks, each one of the end flap crushing pad being positioned between the outer edge of the frame, a corresponding one of the end flap creasing rules and a corresponding one of the cutting members.

23. The pair of dies of claim 20, wherein at least one of the first die and the second die comprises medial end panel crushing blocks, each one of the medial end panel crushing blocks protruding from the frame and having a triangular configuration with a first edge proximate to outer edge of the frame and a second edge proximate to a corresponding one of the medial end panel creasing rules.

24. The pair of dies of claim 20, wherein each one of the cutting members extends longitudinally and each one of the end flap creasing rules extends laterally.

25. The pair of dies of claim 24, wherein each one of the cutting members comprises a blade protruding from the first die and a blade receiving member defined into the frame of the second die.
